(19) United States
(12) Patent Application Publication
(10) Pub. No.: US 2022/0125221 A1
(43) Pub. Date: Apr. 28, 2022

(54) SYSTEM AND METHOD FOR CREATING AND SHIPPING A CUSTOMIZED PHOTO MAGNET PRODUCT

(71) Applicant: Tara Ezer, Hollywood, FL (US)

(72) Inventor: Tara Ezer, Hollywood, FL (US)

(21) Appl. No.: 17/082,499

(22) Filed: Oct. 28, 2020

(51) Int. Cl. A47G 1/06; G06F 3/14

(52) U.S. Cl. CPC A47G 1/0638; A47G 2001/0672; G06F 3/14

(57) ABSTRACT

A system and method are provided for creating a customized photo magnet product and shipping the product to single or multiple recipients. In one aspect, the system includes a web-based application with an enhanced user experience for seamlessly creating the customized photo magnet product. The user interface provides the user with the ability to upload a selected photo image from any of multiple sources and overlay the photo image with a customized visual frame including a user-selected background pattern, text and text properties, event-related icons, and other enhancements. In another aspect, the user may select the ship the custom photo magnet product to one or multiple recipients in selected quantities.

### TECHNICAL FIELD

The embodiments generally relate to computerized systems and methods that incorporate a web-based application for creating a customized photo magnet product combining an uploaded photo image and overlaid frame image. The application includes a user-friendly process flow allowing the user to select details related to the overlaid frame image, including a background pattern, a textual caption, colors, fonts, and icons, and further including an improved user interface for shipping the manufactured photo magnet products.

### BACKGROUND

It is often desirable to attach personal photographs of various kinds to metallic surfaces such as kitchen refrigerators, filing cabinets, and the like, for displaying the photographs for personal enjoyment and the enjoyment of others. Historically, the attachment of the photographs is often accomplished by using discrete magnets on the border of the photograph to capture the photograph between the magnet and the metallic surface.

More recently, magnetic frames have been available to hold photographs to the metallic surface. The frames are generally plastic carriers that provide a slot for inserting a physical photo. The frames include physical magnets usually glued to the backside of the frame for attaching the inserted photographs to refrigerators and other surfaces.

These plastic frames have drawbacks. Plastic frames may be difficult to use and photographs may be damaged when inserting or removing them from the plastic frame. It is also difficult to align photograph evenly in the plastic carrier. Furthermore, if it is desired to make copies for distribution to friends, relatives, and associates, the photographs and frames must be duplicated. This method is costly and inefficient, especially when involving multiple frames.

Even more recently, magnetic printer paper has become available, which contains a metallic layer bonded to a conventional printing surface. This allows photographs to be printed directly on the magnetic printer paper, so that the displayable photo is, in fact, a magnet in itself, or a photo magnet. Photographs directly bonded with a magnetic backing are much more versatile. One advantage is that the same image can be printed multiple times cheaply and in quantity. Some websites have evolved to allow users to upload photos for the purpose of having them printed on magnetic paper.

One of the drawbacks of existing websites of this kind is the complex process flow, which is generally difficult for a user to properly follow to achieve satisfactory results. Application screens on such websites may provide the user with too many choices. In such, a user can easily become confused and frustrated by trying to select all the various options that may be presented in in a single screen to create the desired photo magnet. It is known that when the user experience (UX) is complex, illogical, or non-intuitive, users can be discouraged from using the website at all.

It would also be desirable to create specialized photo magnets related to social events that have occurred or will occur in the future. Magnets may include images and other information related to birthdays, wedding announcements, or various celebrations. In the case of upcoming events such as a wedding or birthday celebration, a photo magnet displayed in a conspicuous place, such as a kitchen refrigerator, may serve as a constant visual reminder of the upcoming event, such that the persons seeing the magnet may remember to make preparations for that event, such as buying gifts in advance. There is a need to provide specialized photo magnets as described, and a method for creating such magnets in a user-friendly manner. It would further be desirable to include decorative framing around the photo, including festive colorings, patterns, icons, captions and other indices to provide information about the event.

In another aspect, video-conferencing web applications are increasingly important, beyond mere business use. Video conferencing applications have grown more prevalent in day-to-day life, such as Zoom and Microsoft Skype. For example, Zoom is a cloud-based platform for video and audio conferencing, chats, and webinars, which allows users to conduct meetings, record sessions, collaborate on projects, and share or annotate one another's computer screens, all with one easy-to-use platform.

In the new realities of COVID-19 wherein social distancing is vital to prevent the spread of harmful viruses, personal celebrations are more frequently conducted over video conferencing applications. These web-based platforms, such as Zoom, are thereby evolving from business-related video conferencing applications to hosting personal events, allowing multiple participants to communicate at a distance for a variety of purposes. These events and celebrations may include, parties, weddings, birthday celebrations, graduations and the like, wherein it is safer or advisable to conduct these events remotely and without physical interaction with the other participants. Unfortunately, a wedding celebration on video conference application may not have the same impact as a traditional celebration with attendees all at one physical location. It would therefore be desirable to enhance the experience of these special events, such as by using screen captures of the video conference event to create commemorative photo magnets that can be distributed to the attendees, providing a tangible memory record of the special celebration.

To overcome these deficiencies in the prior art, it would be desirable to provide a system for the creation of photo magnets and other photo-bearing products which is easy to use and intuitive and wherein the user is guided through a series of predefined selection screens, step-by-step, as the photo magnet is designed, finalized, and shipped. It would further be desirable to create an intuitive user interface that provides the user with a pleasing user experience, which promotes further use of the web-based application.

### SUMMARY OF THE INVENTION

This summary is provided to introduce a variety of concepts in a simplified form that is further disclosed in the detailed description of the embodiments. This summary is not intended to identify key or essential inventive concepts of the claimed subject matter, nor is it intended for determining the scope of the claimed subject matter.

The embodiments provided herein relate to a system and method, including a web-based application for creating a customized photo magnet product or related product and shipping the product to single or multiple recipients.

A host computer system comprises a computer including a processor and memory and a network interface in operable communication to a network so that users may communicate with the host system. The network interface is in operable communication to an application server, which generates the website, and is accessible to users on the network. Multiple users may access the application server and upload photographs from one or more sources of stored digital photographs. Photographs may be uploaded from the users' desktop computers, laptops, and mobile computing devices. Photographs may also be uploaded from social media sites.

The application server provides a user interface which is accessible to users on the network. The application server includes a user interface, user database, an order processing module, a magnetic printing module, and a magnet shipping module.

The user interface is visually displayed on the user's computer screen or mobile display. The user interface is in operable communication to the user database, the order processing module, the magnetic printing module, and the magnet shipping module. In one aspect, the website may include a subscriber or membership feature. In this case, the user database may store members' photos, prior photo magnet designs, personal event listings, personal event reminders, recipient names and shipping addresses for photo magnetic products, and other personalized information for the member.

The user database, which stores information related to current and past photo magnet designs, is in operable communication with the magnetic printing module, which is further in operable communication to a magnetic printing system. The magnetic printing module receives the finished photo magnet designs from the user database and supervises the printing of the photo magnets, according to the user's preferences. The magnetic printing system uses magnetic paper, comprising a printing surface a magnetic material bonded to the printing surface. The magnetic printing system prints the user's finalized photo magnet design on magnetic paper.

In operation, the user logs on to the website and, following the screen prompts, uploads a photograph or photographs from one or more sources of stored digital photographs. Photographs may be uploaded from desktop computers, laptops, and mobile computing devices such as tablets or iPhones. The user is then guided through a series of easy-to-follow selection screens, and the photo magnet product is built up step-by-step, with the user responding to simplified selections related to the creation of a frame overlay. The user makes choices related to pattern, color, caption, font, and event-related icon. The user continues with this guided process until the final design of the frame overlay is completed and the photo magnet design is ready for printing.

In another aspect, the user is provided with the ability to ship chosen quantities of the completed photo magnet to a single recipient, or multiple recipients.

In some embodiments, the system includes a web-based application with an enhanced user interface that provides an enhanced user experience for seamlessly creating a customized photo magnet product. The user interface provides the user with the ability to upload a selected photo image from any one of multiple sources and overlay the photo image with a visual frame. The overlaid frame is built up step-by-step through multiple screens, where the user may select background patterns and colors, text and fonts, event related icons, and other enhancements.

In another aspect, the user may select a quantity of photo magnets for shipping. The user may choose to ship all the completed magnet to one recipient at a single address. Alternatively, the user may choose to ship the photo magnet to multiple recipients in selected quantities.

In another aspect, the website may provide a subscription feature, where the user may easily select recipients from a stored name-and-address listing. In another aspect, a subscribing user may receive reminder notifications of upcoming events, like anniversaries, birthday parties, and the like, so that the user may upload photos related to the upcoming event from various sources, including uploaded photo album collections. Customized photo magnets will subsequently be created which are related to the upcoming events. The user can then choose those recipients who should receive the new photo magnets. In addition, the system will retrieve stored recipient name-and-address listings and send the customized photo magnets to those recipients.

In still another aspect, photo magnets are created in connection with video-conferencing web applications, which are increasingly important, beyond mere business use. Known, popular video-conferencing applications including Zoom and Microsoft Skype. Zoom is a cloud-based platform for video and audio conferencing, chats, and webinars. Business users of Zoom conduct meetings, record sessions, collaborate on projects, and share or annotate on one another's computer screens, all with one easy-to-use platform.

In the current environment where social distancing is vitally important to prevent the spread of harmful viruses such as COVID-19, personal celebrations are evolving into virtual Zoom events. These celebrations or virtual events may include, parties, weddings, birthday celebrations, graduations and the like, where it is medically safer to conduct these events using remote web-based video-conferencing applications such as Zoom. A wedding celebration on Zoom does not have the same impact as a celebration with attendees at one physical location. However, the present invention provides an advantageous method of using screen capture of the Zoom event to create commemorative photo magnets. Screenshots of the special event are taken through the Zoom interface through a suitable API. Screenshots of events may conveniently be taken once the event is completed, and custom photo magnets may be created from the screenshots of the events. The photo magnets, containing a variety of images from the virtual event, may then be packaged and shipped to guests and multiple addresses. The variety of images from the virtual event will commemorate and encapsulate memories of those events.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates a block diagram of the application system, according to some embodiments;

FIG. 2A illustrates a block diagram of the process flow of the user interface, particularly showing the magnet creation and customization flow of the invention, according to some embodiments;

FIG. 2B illustrates a block diagram of the process flow of the user interface, particularly showing the shipping flow of the invention, according to some embodiments;

FIG. 3 illustrates a screenshot of the welcome screen, according to some embodiments;

FIG. 4 illustrates a screenshot of the photo upload screen, according to some embodiments;

FIG. 5 illustrates a screenshot of the photo upload screen showing the upload progress bar, according to some embodiments;

FIG. 6 illustrates a screenshot of the frame selection screen, according to some embodiments;

FIG. 7 illustrates a screenshot of the frame selection screen with user selections in progress, according to some embodiments;

FIG. 8 illustrates a screenshot of the text box screen, according to some embodiments;

FIG. 9 illustrates a screenshot of the text box screen with user selections in progress, according to some embodiments;

FIG. 10 illustrates a screenshot of the icon selection screen, according to some embodiments;

FIG. 11 illustrates a screenshot of the icon selection screen with user selections in progress, according to some embodiments;

FIG. 12 illustrates a screenshot of the magnet purchase screen, according to some embodiments;

FIG. 13 illustrates a screenshot of the member sign-up screen, according to some embodiments;

FIG. 14 illustrates a screenshot of the magnet shipping screen, according to some embodiments;

FIG. 15 illustrates a screenshot of the recipient address screen, according to some embodiments;

FIG. 16 illustrates a screenshot of the checkout screen, according to some embodiments;

FIG. 17 illustrates a screenshot of the shipping options screen, according to some embodiments;

FIG. 18 illustrates a screenshot of the order summary and billing screen, according to some embodiments; and

FIG. 19 illustrates a screenshot of the closing screen for the application, according to some embodiments.

### DETAILED DESCRIPTION OF THE PREFERRED EMBODIMENTS

The specific details of the single embodiment or variety of embodiments described herein are to the described system and methods of use. Any specific details of the embodiments are used for demonstration purposes only, and no unnecessary limitations or inferences are to be understood therefrom.

Before describing in detail the exemplary embodiments, it is noted that the embodiments reside primarily in combinations of components and procedures related to the system.

Accordingly, the system components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

In general, the embodiments provided herein relate to a web-based system for guiding a user through the steps of designing a customized photo magnet product, finalizing the design, and ordering physical photo magnet products from the website with photo magnets delivered to single or multiple addresses as designated by the user.

In another aspect, the invention is a software-based platform, comprising a novel method for a user to upload a personal photograph and create and customize a photo frame overlayed on top of the user's photo. The end product is a photo magnet which is manufactured for delivery to the user. The website/mobile application of the present invention allows end users to seamlessly customize a personalized photo magnet frame. The user is guided through a step-by-step process of easy to follow web-screen prompts to customize an overlaid frame with: frame patterns and colors; text content, style, fonts and colors; and icon imagery. The finished product may be shipped to a single recipient and address or to multiple recipients at multiple addresses.

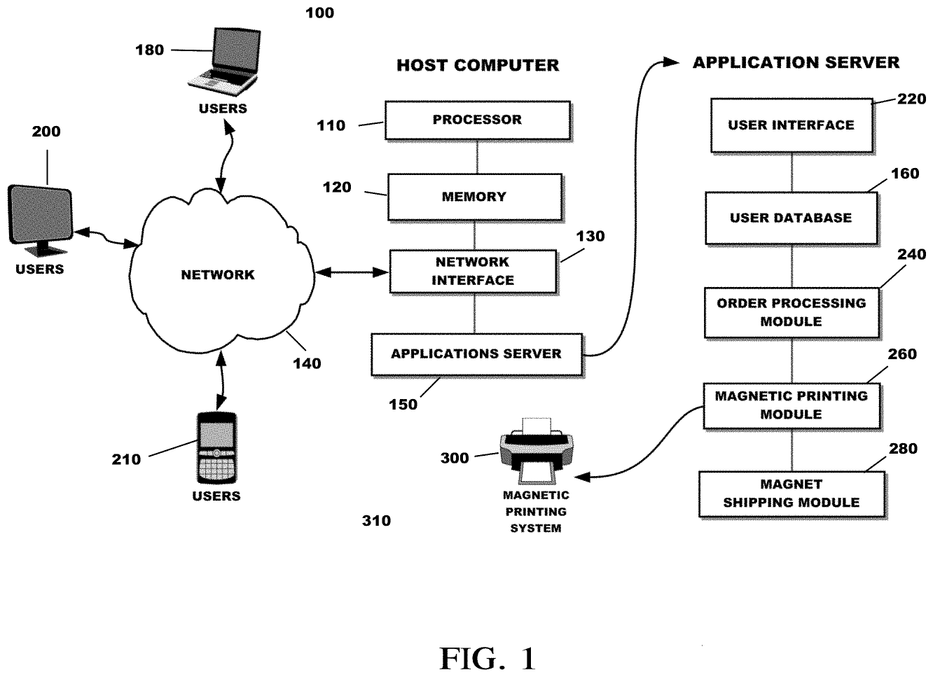

FIG. 1 illustrates an exemplary system according to the present invention. FIG. 1 illustrates a computer system 100, which may be utilized to execute the processes described herein. The computer system 100 comprises of a host computer, which may be a stand-alone computer, a mobile computing device, a mainframe computer system, a workstation, a network computer, a desktop computer, a laptop, or the like. The computer system 100 includes one or more processors 110 coupled to a memory 120. The computer system 100 may further include a network interface 130 to communicate with a network 140. As in the conventional computer system, it is understood that various local and remote I/O devices may be coupled to the computer 100 to input and output instructions and data to and from the processor 110 and memory 120.

Processors 110 suitable for the execution of a computer program include both general and special purpose microprocessors and any one or more processors of any digital computing device. The processor 110 will receive instructions and data from a read-only memory or a random-access memory or both. The essential elements of a computing device 100 are a processor 120 for performing actions in accordance with instructions and one or more memory devices 120 for storing instructions and data. Generally, a computing device 100 will also include, or be operatively coupled to receive data from or transfer data to, or both, one or more mass storage devices for storing data, e.g., magnetic, magneto-optical disks, or optical disks; however, a computing device need not have such devices. Moreover, a computing device 100 can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive).

A network interface 130 may be configured to allow data to be exchanged between the computer system 100 and other devices attached to a network 140, such as other computer systems, or between nodes of the computer system 100. In various embodiments, the network interface 130 may support communication via wired or wireless general data networks, such as any suitable type of Ethernet network, for example, via telecommunications/telephony networks such as analog voice networks or digital fiber communications networks, via storage area networks such as Fiber Channel SANs, or via any other suitable type of network and/or protocol.

The memory 120 may include application instructions for an application server 150, configured to implement certain embodiments described herein, and a database 160, comprising various data accessible by the application server 150. In one embodiment, the application server 150 may include software elements corresponding to one or more of the various embodiments described herein. For example, application server 150 may be implemented in various embodiments using any desired programming language, scripting language, or combination of programming languages and/or scripting languages (e.g., C, C++, C#, JAVA®, JAVASCRIPT®, PERL®, etc.). In addition to application instructions for the application server 150, the memory 120 may be used to store data of various types in accordance with the invention.

The computer system 100 with its processor 110, memory 120, and network interface 130 are in operable communication to the network 140 such that users 180, 200, 210 may communicate with the host computer system 100. The network interface 130 is in operable communication with an application server 150, which generates an application website and user interface 150 and is accessible to users connected to the network 140. Multiple users 180, 200, 210 may access the application server 150 and upload photographs from one or more sources of stored digital photographs. Photographs may be uploaded from the users' desktop computers 200, laptops 180, and mobile computing devices 210.

The application server 150 of the present invention provides a user interface 220, which is accessible to users on the network 140. The application server 150 includes a user interface 220, a user database 160, an order processing module 240, a magnetic printing module 260, and a magnet shipping module 280.

The user interface screens 220 are visually displayed on the user's computer screen 200 or mobile display 210. The user interface 220 is in operable communication to the user database 160, the order processing module 240, the magnetic printing module 260, and the magnet shipping module 280.

In one aspect, the website may include a membership feature for a user. In this case, the user database 160 may include a member's photos, stored photo magnet designs, personal event listings, personal event reminders, recipient names and addresses for photo magnetic products and other personalized information for the member.

The order processing module 240 stores information related to a user's current and past photo magnet designs. The magnetic printing module 260 stores the completed photo magnet designs and supervises printing according to the users preferences.

The magnetic printing module 260 is further in operable communication to a magnetic printing system 300. The magnetic printing system uses magnetic paper, comprising a printing surface a magnetic material backing bonded to a printing surface. The user's photo magnet design is printed on the magnetic printing system 300, according to the user's choices to create a completed physical photo magnet 310.

In operation, the user logs on to the website 220 and uploads a photograph or photographs from one or more sources of stored digital photographs. Photographs may be uploaded from desktop computers 200, laptops 180, and mobile computing devices 210 such as tablets or mobile phones. Photos may also be uploaded through social media websites, such as Facebook or Twitter. The user then follows a guided process wherein the photo magnet product is designed step-by-step, with the user responding to simplified selections related to the creation of a frame overlay. The user is guided through easy-to-follow web-screen prompts to customize an overlaid frame with: frame patterns and colors; text content, style, fonts and colors; and event-related icon imagery. The user continues with this guided process until the final design of the frame overlay is completed and the photo magnet design is ready for printing on the magnetic printing system 300.

The steps and actions of the computer system 100 described in connection with the disclosed embodiments may be embodied directly in hardware, in a software module executed by a processor 110, or in a combination of the two. A software module may reside in RAM, flash memory, ROM memory, EPROM memory, EEPROM memory, registers, a hard disk, a removable disk, a CD-ROM, or any other form of storage medium known in the art. An exemplary storage medium may be coupled to the processor 110 such that the processor 110 can read information from, and write information to, the storage medium. In the alternative, the storage medium may be integrated into the processor 110. Further, in some embodiments, the processor 110 and the storage medium may reside in an Application Specific Integrated Circuit (ASIC). In the alternative, the processor 110 and the storage medium 120 may reside as discrete components in a computing device 100. Additionally, in some embodiments, the events or actions of a method or algorithm may reside as one or any combination or set of codes and instructions on a machine-readable medium or computer-readable medium, which may be incorporated into a computer program product.

Further, any connection may be associated with a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. “Disk” and “disc,” as used herein, include compact disc (CD), laser disc, optical disc, digital versatile disc (DVD), floppy disk and Blu-ray disc where disks usually reproduce data magnetically, while discs usually reproduce data optically with lasers. Combinations of the above should also be included within the scope of computer-readable media.

In some embodiments, the system is world-wide-web (www) based, and the network server is a web server delivering HTML, XML, etc., web pages to the computing devices. In other embodiments, a client-server architecture may be implemented, in which a network server executes enterprise and custom software, exchanging data with custom client applications running on the computing device.

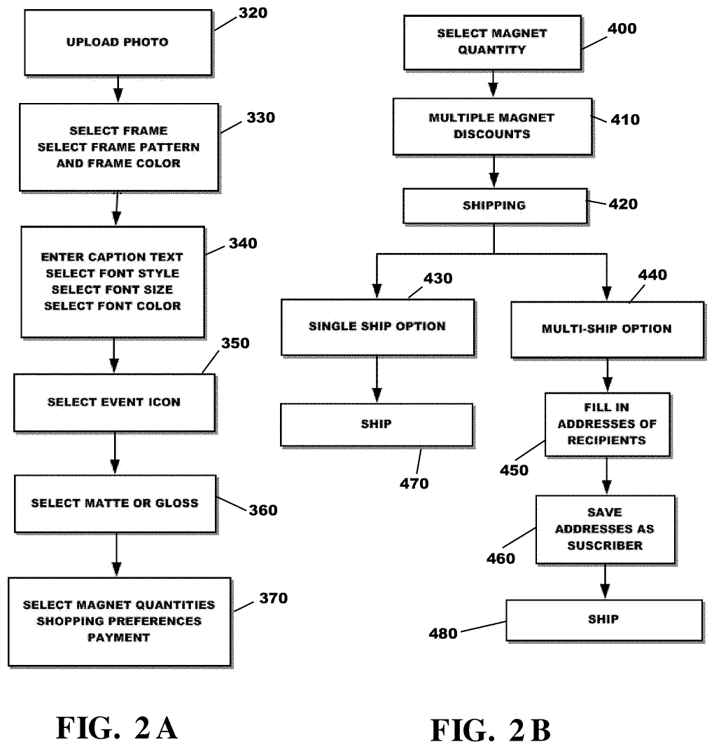

FIG. 2A and FIG. 2B illustrate in block diagram form an exemplary embodiment of the process flow of a user interface for the creation of customized photo magnets, and the novel shipping flow of the invention, respectively. Starting with FIG. 2A, the customization of an overlaid photo frame is shown. At the start of the process, the user uploads a photograph to the website. The photograph will serve as the basis for a customized photo magnet product 310. In step 320, the user successfully uploads the desired photograph. The user is then presented with a series of guided computer screens in which user selections are made to customize the photo magnet. The series of screens guide the user through the process of creating a customized photo magnet as the user makes prompted selections and choices. As the user makes selections and choices, the leftmost part of the screen will display a mockup of the final product based on the current customizations as selected by the user.

In step 330, the user selects the option of having a frame or no frame. If the user chooses a frame, options will be presented for the user to select a frame pattern and frame color on the following screen. In step 340, the user will be presented with choices for entering a caption or text. If a caption is chosen, the user may enter the caption text, the font style, the font size, and the font color. A list of popular fonts are presented on the screen, as will be further described hereinbelow. It is contemplated that customized fonts may also be included.

In step 350, the user is presented with choices for an event icon. An event icon is comprised of a small graphic associated with an event, and which will particularize the frame with an indication of the upcoming event. For example, a birthday cake icon may be used to represent an upcoming birthday. There are multiple choices, which the user can select to identify several common events. If the resulting photo magnet includes an icon, the purpose of the magnet will be readily discernible, especially when it is attached to a metallic surface like a refrigerator for display.

As the customization continues in step 360, the user is provided with a choice of selecting a matte or gloss finish for the completed photo magnet product 310. This final selection completes the photo magnet customization process.

In step 370, with the magnet customization process completed, the user selects magnet quantities, shipping preferences, and payment options.

Turning now to FIG. 2B, the shipping process is described in greater detail. In step 400, the user is presented with a screen for purchasing magnets in a user specified quantity. If multiple magnets are purchased, the user is presented with the choice of multiple magnet discounts in step 410, which provides discounts for purchasing magnets in specific quantities. The step 420 begins the shipping process, according to the present invention.

The application provides a single ship option 430 or a multi-ship option 440. The single ship option 430 involves sending products to one recipient. The quantity of magnets is chosen, and these are shipped in step 470 to a single name and address. The multi-ship option 440 allows the user to send chosen quantities of photo magnets to two or more different addresses. In the multi-ship option 440, the user fills in the addresses of each of the multiple recipients along with the quantity of magnets that each will receive. For example, the user may choose to send 3 magnets to address A; send 2 magnets to address to B; and send 5 magnets to address C.

A membership or subscriber feature 460 will allow the user to store the multiple addresses in the form of a user address book within the user database 160, as previously described. The user database 160 may include a member's photos, stored photo magnet designs, personal event listings, personal event reminders, recipient names and addresses for photo magnetic products, and other personalized information for the member. If the user desires to order a large quantity of magnets, the website will allow them the ability to upload a .csv file or similar file to automate populating shipping information for the multi-shipping process. When the shipping selections are made, the process flow proceeds to block 480, which is the shipping of the photo magnet products 310. If the user enters more than ten addresses, the system prompts the user and suggests that the user open an account, as the user may be prepping to host a large event. The website suggests to the user that an XL file can be uploaded including multiple addressees, which can then be conveniently selected, with the shipping addresses.

In other embodiments, for repeat customers, the website uploads multiple recipient data so that the addressees can be pulled from the user database 160 for the repeat customer, using a lookup table of previous addressees associated with that repeat customer. The previous addresses can be identified by nicknames for those previous addresses, such that a repeat customer only needs to click on those nicknames and the associated addresses will be automatically selected and entered for shipping. It is further contemplated that, using a subscription-based model, a user may order a certain amount of many magnets per month for monthly fee. It is also contemplated that the user will be able to purchase a VIP membership, wherein a quantity of photo magnets 310 will be available on a monthly basis, and it is contemplated that the website will send the user reminder messages for upcoming special events, such as birthdays, and suggest that magnets be created and sent to a list of users to commemorate those special events.

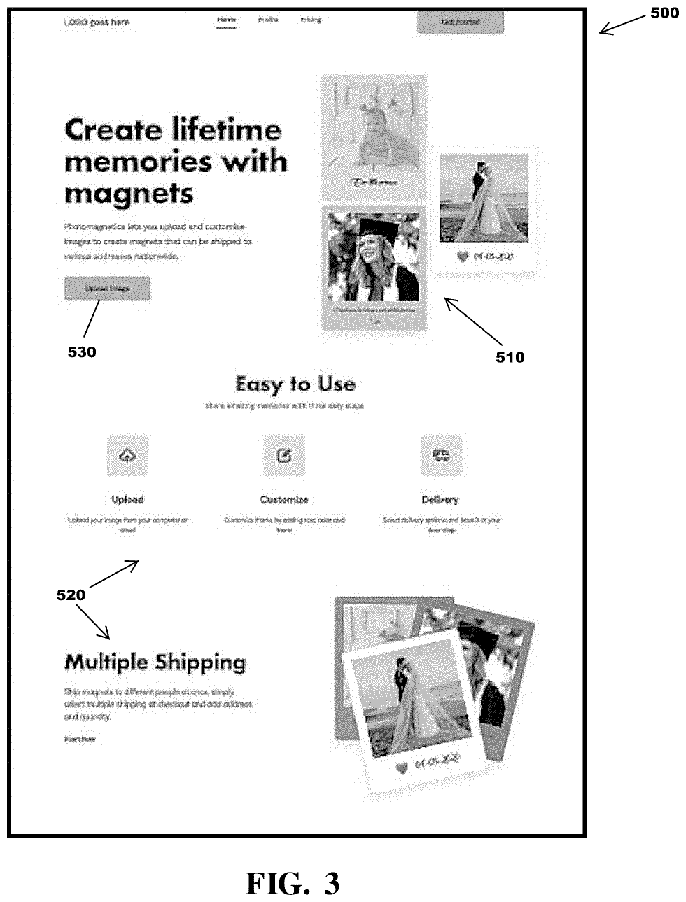

Turning now to the exemplary display screens for the user interface 220, FIG. 3 shows the welcome screen 500 for the user interface 220. The screen introduces the user to the website, provides example images 510 and explains some of the main features 520, including the uploading, customizing, and delivery options. It will be noted that every part of the user interface has been designed to maximize the user experience as a guided process, wherein the features are presented screen-by-screen, in a manner which is lucid, intuitive, and enjoyable to use. From the welcome screen, the user may click on the upload image icon 530 and proceed with creating a customized photo magnet 310.

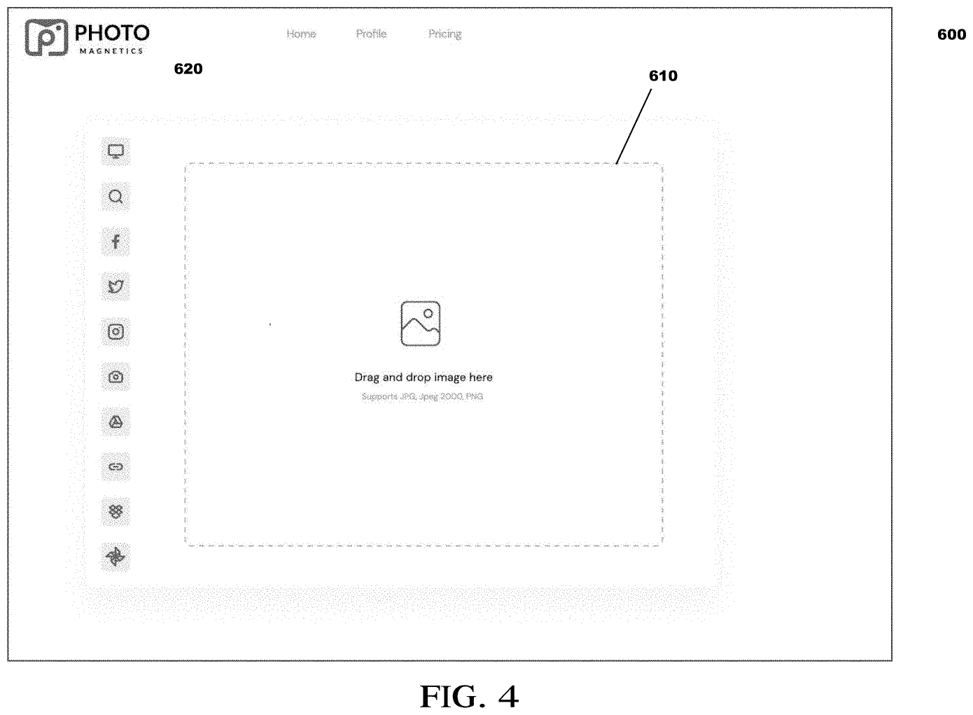

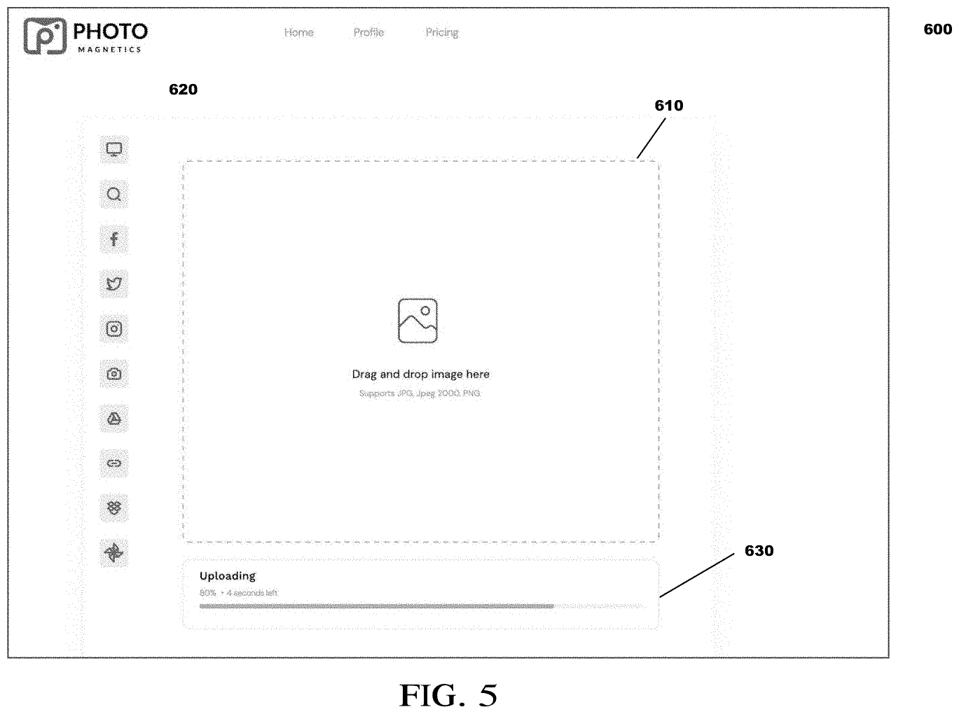

FIG. 4 illustrates a screenshot of the photo upload screen 600, according to some embodiments. A source photo may be in the form of any of several supporting image formats such as JPG, Jpeg 2000, and PNG. A drag-and-drop feature helps the user position the uploaded image within the image area 610. The image may be uploaded by the user from various image sources 620, as indicated in the icon listing to the left of the image area, including a computer, a digital camera, a mobile device, and also from social media sites like Facebook, Twitter, and the like. FIG. 5 illustrates a screenshot of the photo upload screen, showing the upload progress bar 630, according to some embodiments. On this screen, the user may observe the progress of the image being uploaded.

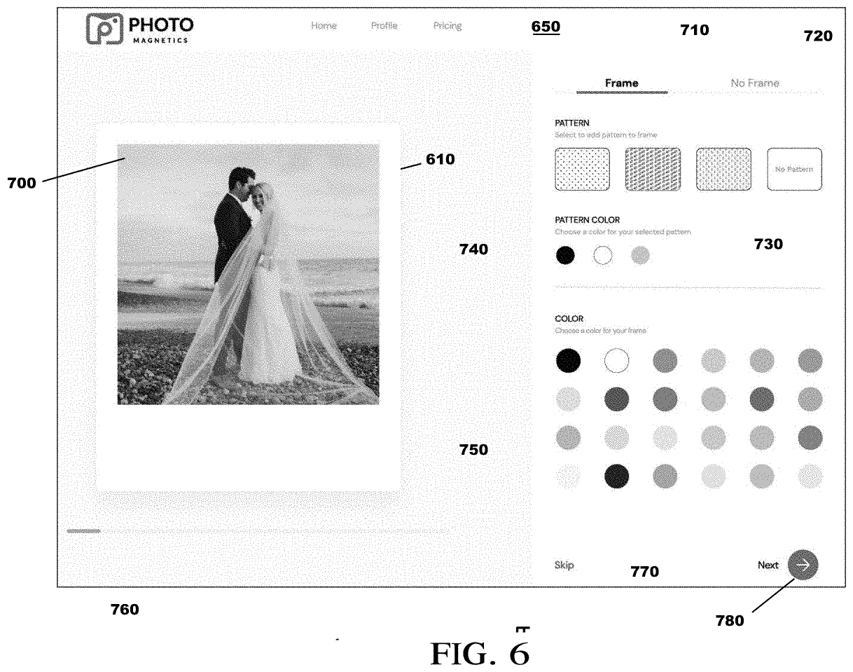

FIG. 6 illustrates a screenshot of the frame selection screen 650. In this screen, the source photo 700 has been uploaded and resides in the image area 610. The source photo 700 in the present example is from a wedding. In this screen, the user may select a frame 710 or no frame 720. Selecting no frame 720 will create a photo magnet without any frame surrounding the source photo 700. When the user chooses a frame 710, there are several options presented. First, there is the frame pattern 730 which may be chosen from a selection of patterns by clicking on any of the displayed palette of patterns. The user may also choose no pattern. When a pattern is selected, the user may choose a pattern color 740 by clicking on the displayed pattern colors. Next, the user may select a color for the overall frame from a palette of color selections 750, which are displayed for the user. The progress bar 760 then displays the progress for the creation process of the customized photo magnet. As shown in FIG. 6, the progress bar 760 indicates the progress for the process of creating the photo magnet design prior to the user making user selections regarding the frame. If desired, the user may skip these features and proceed to the next screen by clicking the skip icon 770. When the desired selections on the screen have been completed, the user selects the next icon 780.

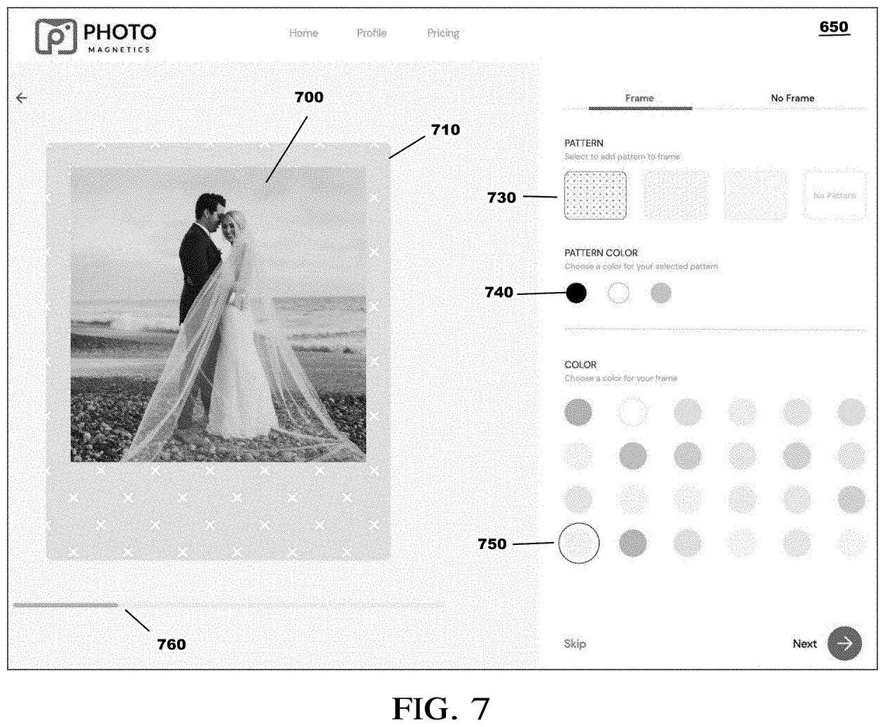

FIG. 7 illustrates a screenshot of the frame selection screen 650 with user selections in progress. In this screen, the progress of creating the frame 710 is shown, providing a visual guide to the user. The user then sees displayed the source photo 700 combined with the frame 710, wherein the selections are in place such that the pattern 730 has been chosen, the pattern color 740 has been chosen, and the frame color 750 has been chosen. All these choices together are displayed in the image of the frame 710 surrounding the source photo 700. The progress bar 760 thereafter indicates further progress toward the final photo magnet design.

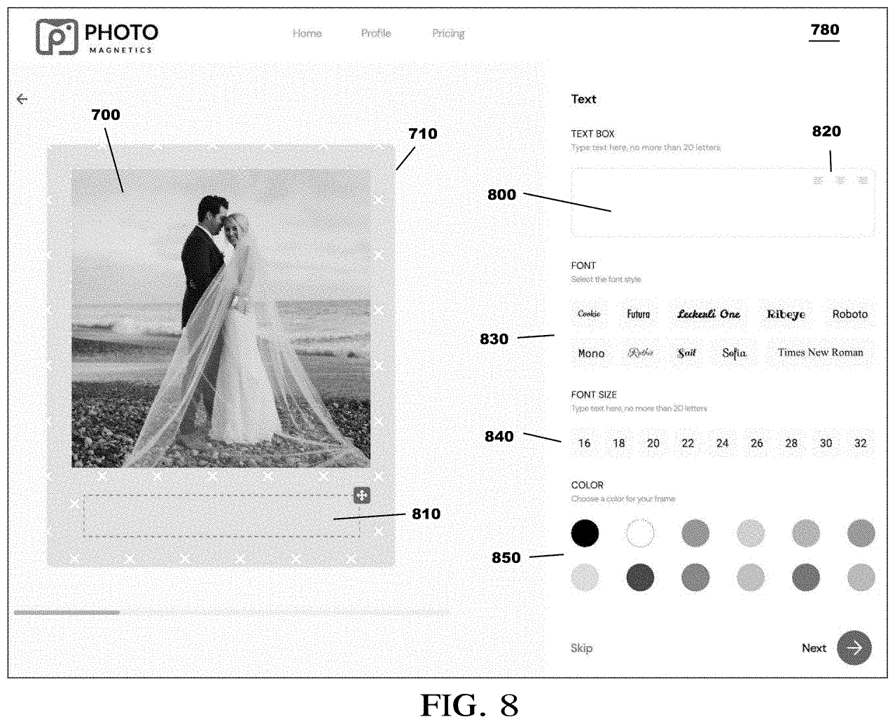

FIG. 8 shows the next screen in the sequence, the text box screen 780, which provides a text box 800 for the user to enter a caption or text on the frame 710. The user enters the chosen text in the text box 800, such that the text will be displayed in the corresponding frame text box 810 under the source image 700. The text box 800 includes justification indicators 820 and alignment indicators for aligning the text in the text box 800. The user may choose from any of the font styles 830 displayed. It is contemplated that additional fonts may be selected in some embodiments, including fonts customized just for the present application. The user then chooses a font size 840, and a font color 850. The user's choices are reflected in the displayed image of the frame 710.

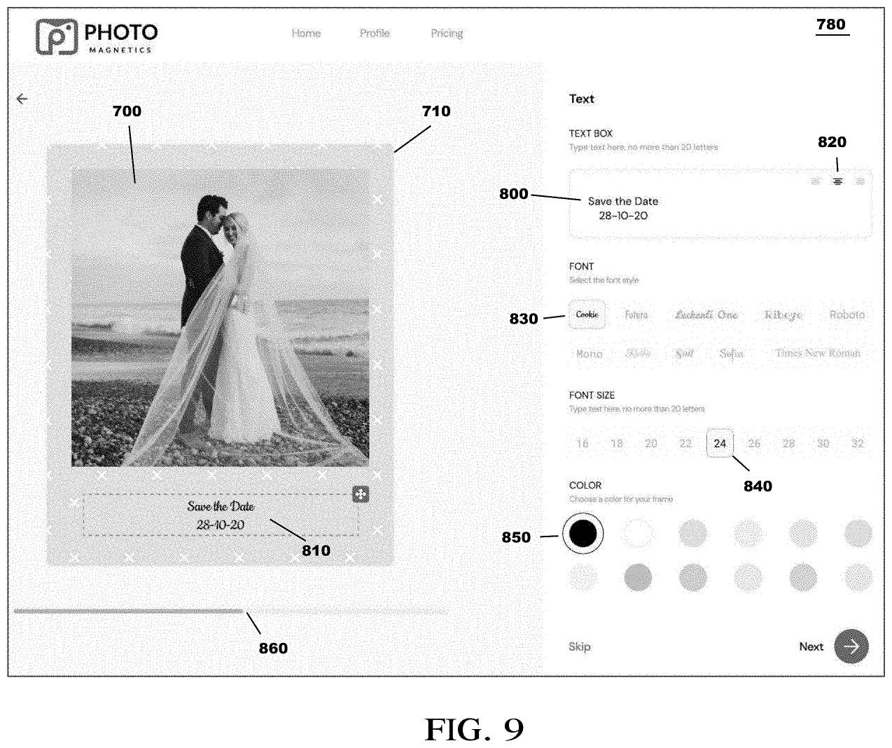

FIG. 9 illustrates a screenshot of the text box screen 780 with user selections in progress, wherein selections have been made by the user such that text has been entered in the text box 800, the text alignment 820 has been chosen, the font style 830 “Cookie” has been selected, the font size 840 has been selected showing 24 point type, and the text color 850 has been chosen as black. As the choices are made, the user selections are displayed in the image of the frame 710 in the corresponding text box 810. The user can see the continuing development of the final photo magnet design as selections are made, and the progress within the process in the progress bar 860.

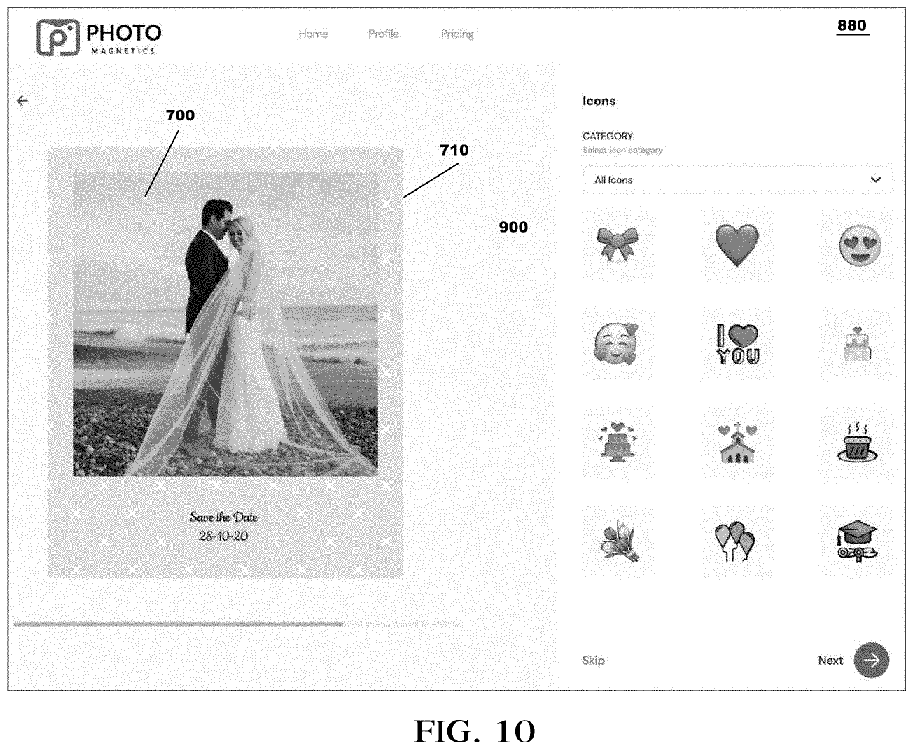

FIG. 10 illustrates a screenshot of the event icon selection screen 880. The purpose of the event icon selection screen is to display an icon 900 on the frame 710 to provide a visual indication of the event associated with the customized photo magnet. Many event icons 900 are indicated for the user's choice. For example, there are icons 900 representing birthdays, weddings, graduations, parties, romance, and several others. If the user chooses to display an event icon 900 on the photo magnet, the user may click on a chosen icon 900 from the choices displayed to add it to the design on the frame 710.

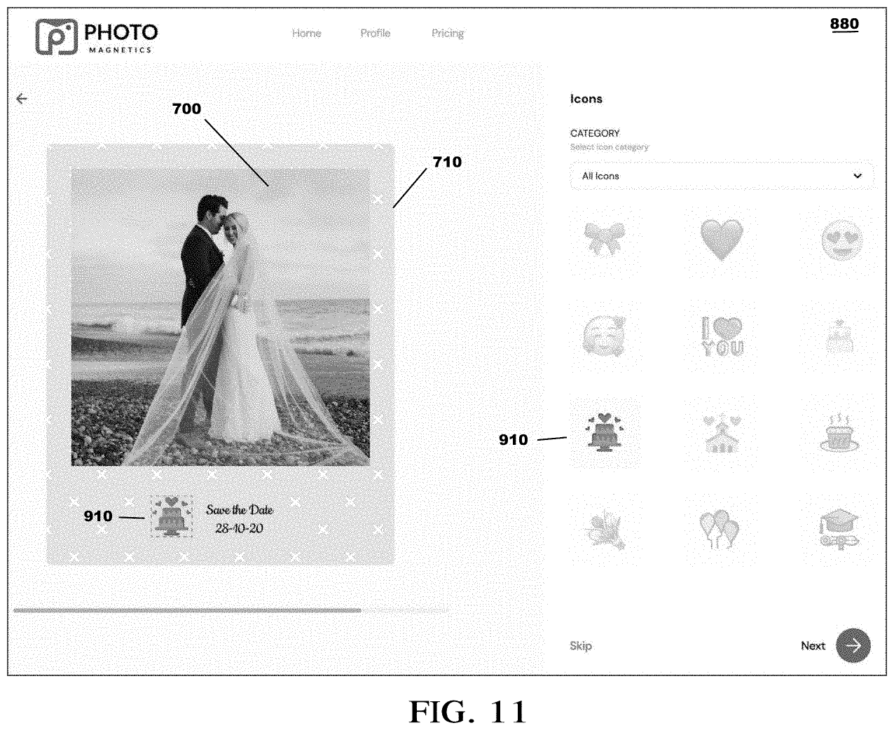

FIG. 11 illustrates a screenshot of the event icon selection screen with the user selections in progress. In this illustration, the icon 910 has been selected by the user and is highlighted on the screen. The icon 910 indicates an upcoming wedding event. The chosen icon 910 is displayed next to the text on the frame 710.

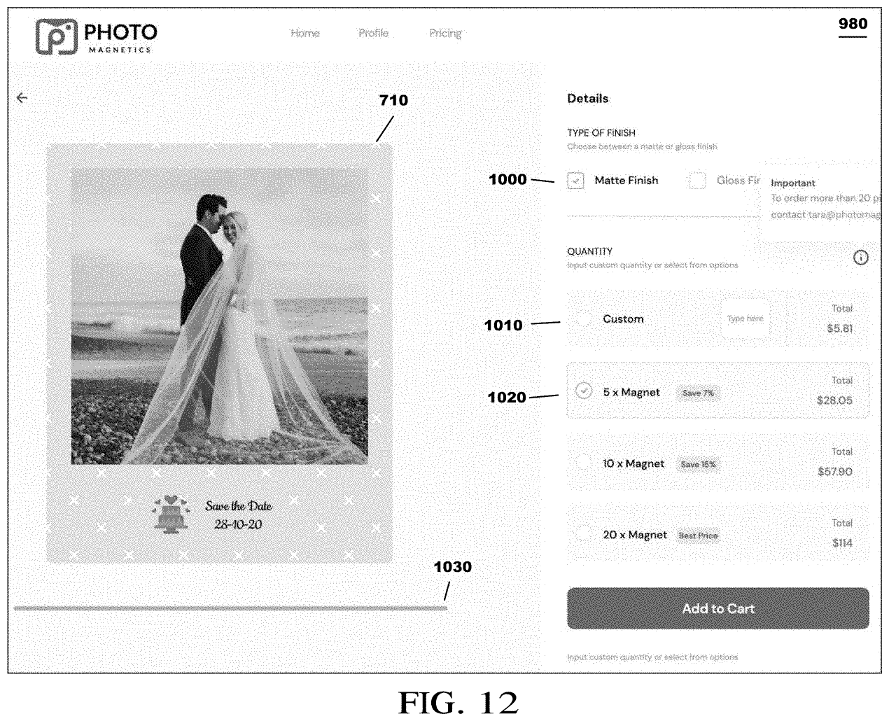

FIG. 12 illustrates a screenshot of the magnet purchase screen 980. The user may choose the type of finish 1000 for the completed photo magnet. The user may choose a matte finish or gloss finish. On this screen, the user may select magnet quantities. A custom quantity 1010 may be entered, or one of several preset quantity 1020 packages may be selected, which include quantity discounts for various quantities. The magnet frame 710 in its final form is illustrated in the figure, showing the completed magnet. Further, the progress bar 1030 then shows completion of the photo magnet design process.

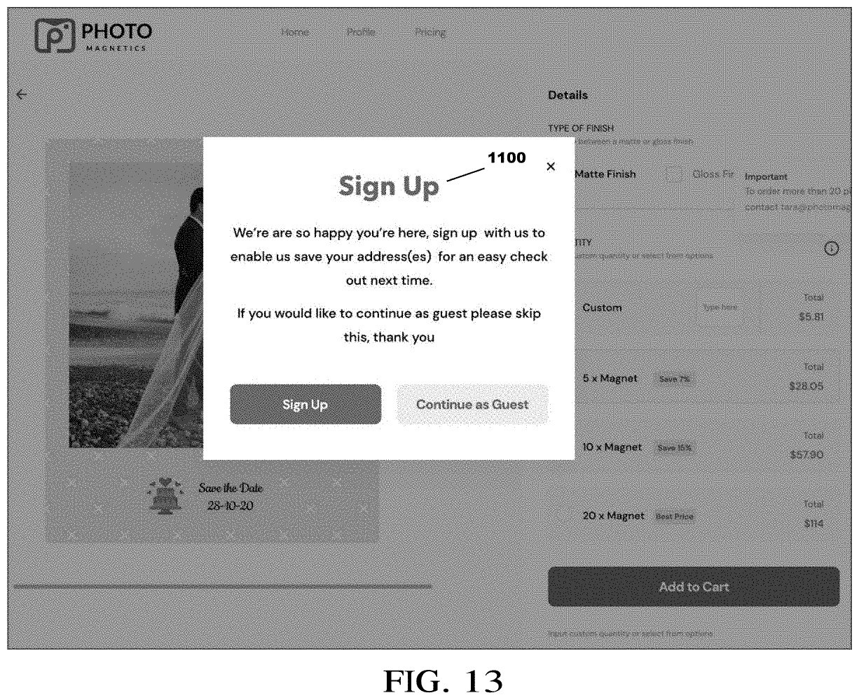

FIG. 13 illustrates a screenshot of the member sign-up screen 1100, which encourages the user to become a member of the website.

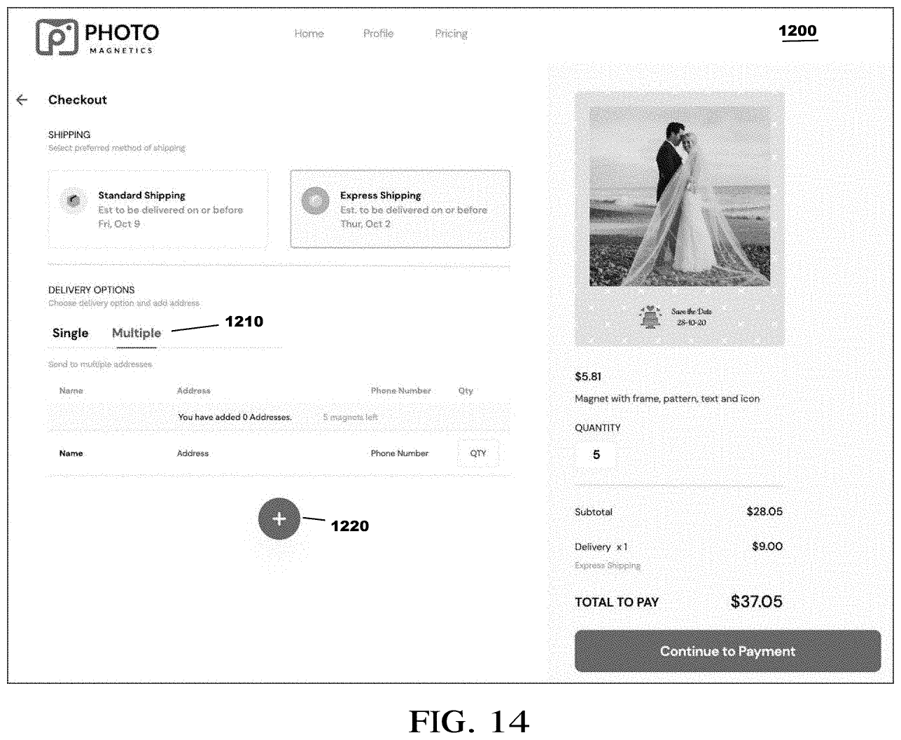

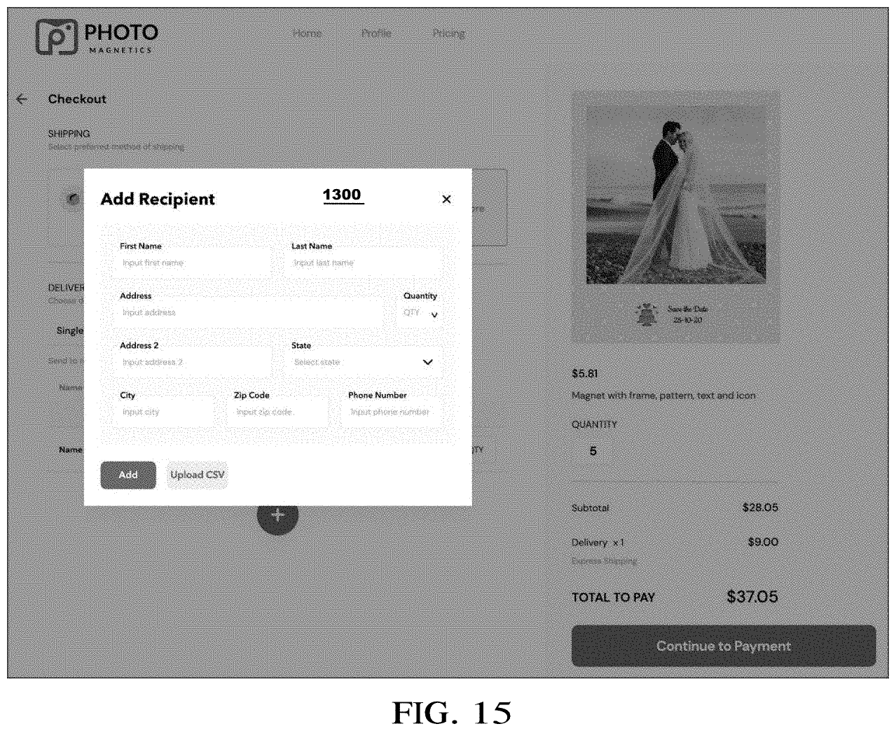

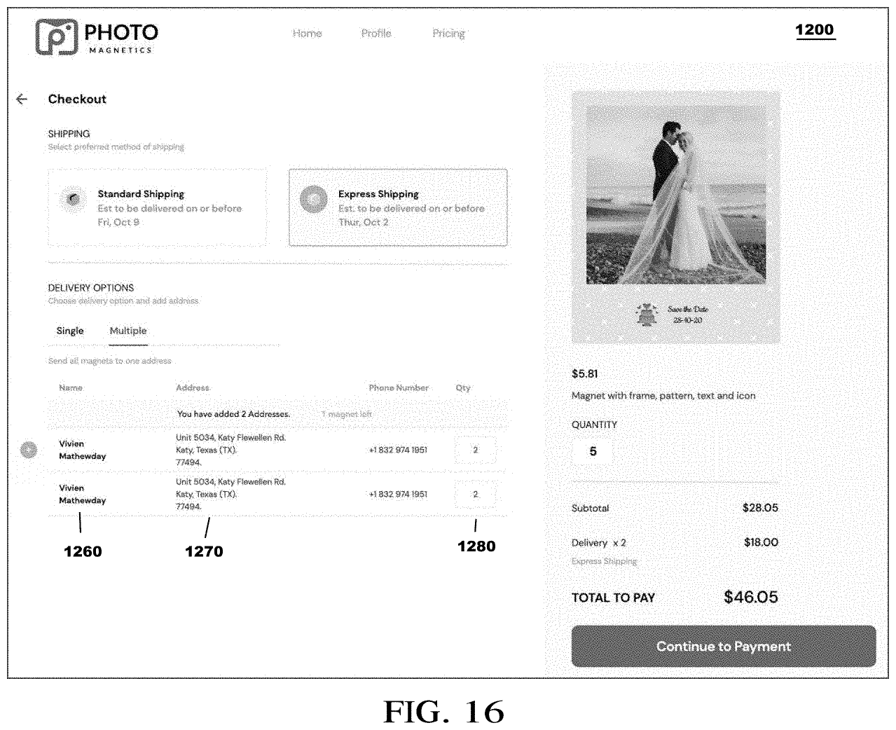

FIG. 14 illustrates a screenshot of the magnet shipping screen 1200. An important feature of the shipping process is the provision for the user to choose delivery options 1210 for single shipping to one address or multiple shipping to several addresses. Multiple addresses may be added by clicking on the add icon 1220, allowing different quantities of physical photo magnets 310 to be shipped to different recipients as described hereinabove. FIG. 15 illustrates a recipient shipping screen 1300, wherein names and addresses of recipients may be added. FIG. 16 illustrates another view of the magnet shipping screen 1200 showing multiple shipping to several addresses and showing an address listing and magnet quantity to be provided for each address. In this screen, the recipients' names 1260 are listed, the recipients contact information 1270 and shipping address are listed, and the quantities 1280 to be shipped to each recipient are listed. FIG. 16 further illustrates a preferred form of the user checkout screen.

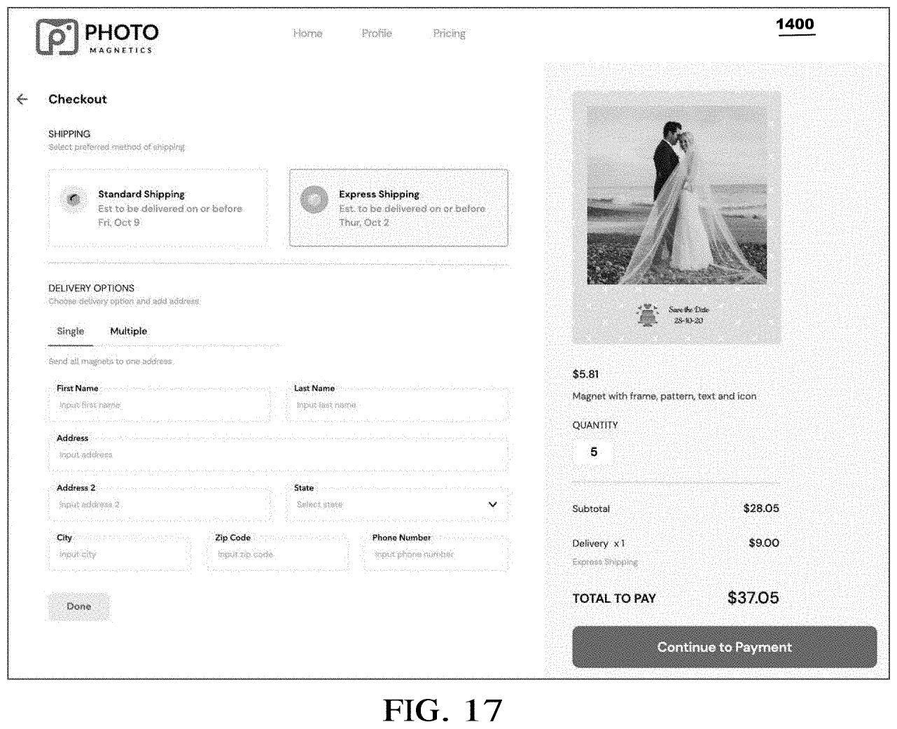

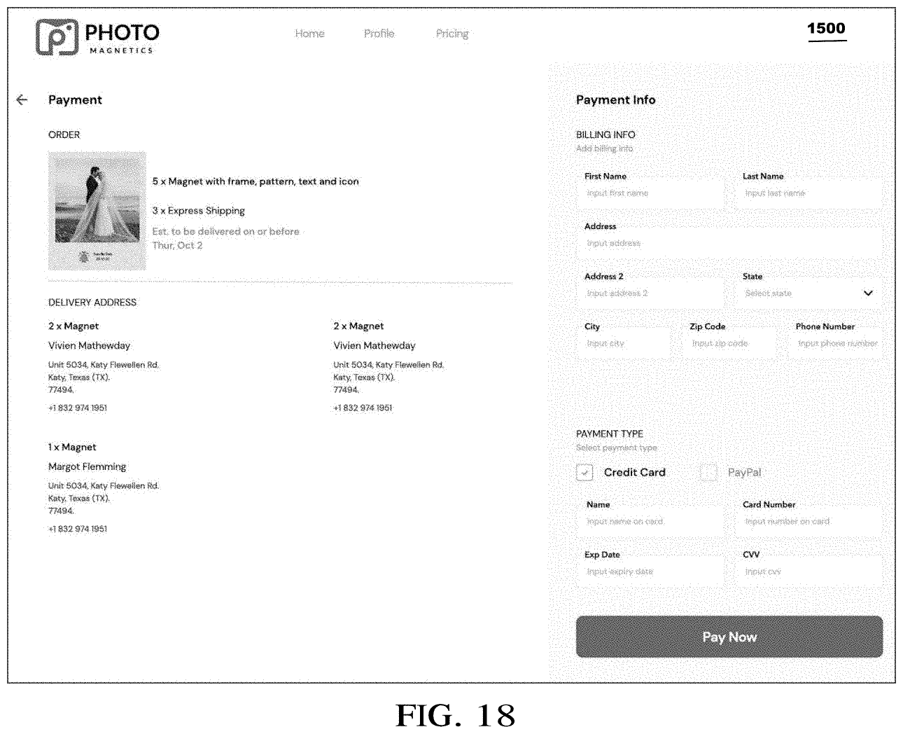

FIG. 17 illustrates a screenshot of the single ship screen 1400, wherein the user has chosen for the completed photo magnets to be shipped to a single address. FIG. 18 illustrates a screenshot of the order summary and billing screen 1500, which shows the number of magnets, the name and shipping address, and other contact information for each of the recipients. Billing information is also provided in this screen 1500.

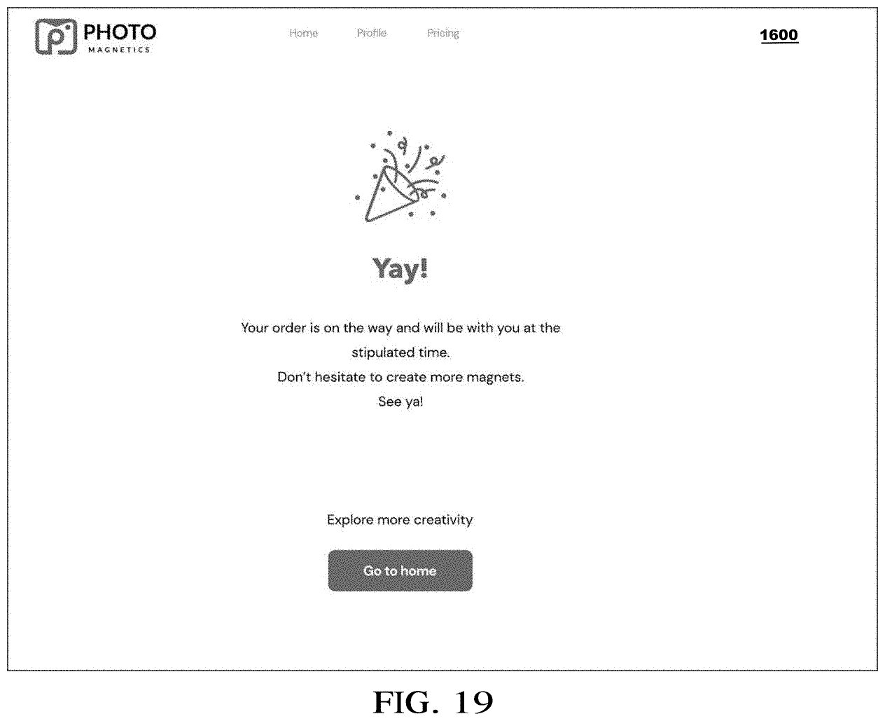

FIG. 19 illustrates a screenshot of the closing screen or “goodbye” screen 1600 presented upon completion of the process, which may direct the user back to a home screen or to the first screen to begin the process for a new order.

In one aspect, the application website of the present invention comprises a design wizard that provides a unique user experience from any competitive systems. In such, the user experience (UX) is enhanced. The workflow is a multistep process of successive easy-to-follow screens that guide the user through the process of creating a customized photo magnet product. Competitive devices have a single screen with too many choices, confusing the user and negatively impacting the user experience (UX). The present invention provides an enhanced user experience by incorporating multiple screens in a step-by-step, simplified creation process, all the while providing the user with a photo magnet preview of the final design in each step.

Many different embodiments have been disclosed herein, in connection with the above description and the drawings. It will be understood that it would be unduly repetitious and obfuscating to describe and illustrate every combination and subcombination of the embodiments. Accordingly, all embodiments can be combined in any way and/or combination, in the present specification, including the drawings, shall be construed to constitute a complete written description of all combinations and some combinations of the embodiments described herein, and of the manner and process of making and using them, and shall support claims to any such combination or subcombination.

An equivalent substitution of two or more elements can be made for any one of the elements in the claims below or that a single element can be substituted for two or more elements in a claim. Although elements can be described above as acting in certain combinations and even initially claimed as such, it is to be expressly understood that one or more elements from a claimed combination can in some cases be excised from the combination and that the claimed combination can be directed to a subcombination or variation of a subcombination.

It will be appreciated by persons skilled in the art that the present embodiment is not limited to what has been particularly shown and described hereinabove. A variety of modifications and variations are possible in light of the above teachings without departing from the following claims.

What is claimed is:

1. A system for creating a customized photo magnet over a network, comprising
a computer in operable connection with a network interface;
a network interface in operable connection with the network;
an application server in operable communication with the network interface, the application server configured to host a website application for creating a customized photo magnet, the server having a user interface for providing a remote user with web-page access to the computer;
the user interface in operable communication with: a user database, an order processing module, a magnetic printing module, and a magnet shipping module;
the user interface comprising a series of separate webpage screens for designing the customized photo magnet by the user, the user interface comprising:
a photo upload screen configured for uploading a user photo into the application;
a frame selection screen configured for providing a frame overlay on the user photo, wherein the user may select at least a frame pattern and a frame color;
a text box screen configured to provide a text box, wherein the user may select caption text, font style, font size, and font color for display on the frame overlay; and
an event icon selection screen configured to provide a selection of event icons, wherein the user may select an icon for display in the frame overlay.

2. The system of claim 1, wherein a mockup of the completed photo magnet is displayed in real time as user selections are made.

3. The system of claim 1, wherein the frame selection screen shows a palette of color selections corresponding to a frame color.

4. The system of claim one, wherein the frame selection screen shows a palette of pattern selections and pattern colors.

5. The system of claim 1, further comprising a magnetic printing system for printing a photo magnet on paper stock having a magnetic backing layer, wherein the photo magnet design has been customized by the user selections.

6. The system of claim 1, further comprising a magnet shipping screen for providing shipping instructions for shipping the photo magnets to a single recipient or multiple recipients.

7. The system of claim 1, wherein shipping information is based on past orders is stored in the user database.

8. The system of claim 7, wherein the shipping information includes names, addresses, and magnet quantities previously ordered for prior recipients.

9. The system of claim 1, wherein the user photos are uploaded from the user's social media websites.

10. The system of claim 1 wherein the user database stores a user's photo album of previously uploaded photos for future use.

11. The system of claim 1, wherein photos related to a virtual event recorded on a video-conferencing website may be sequentially uploaded into the website application, and wherein groups of related photo magnets may be designed, printed, packaged, and shipped to attendees of the virtual event.

12. The system of claim one 11, wherein photos are uploaded from screen captures of the virtual event conducted on the video conferencing website in real time.

13. The system of claim 11, wherein screen captures are made from a recording of a virtual video conferencing event after the event has concluded.

14. A method for providing a customized photo magnet to a user, comprising the steps of:
providing a web-based application over a network for designing a custom photo magnet, the application having a user interface accessible to the user as separate web screens, each screen displaying prompts or menus, wherein the user provides selections in response to the prompts or menus;
displaying a separate photo upload screen, wherein the user selects and uploads a source photo from one of multiple photo sources selected by the user;
displaying a separate frame selection screen, wherein a frame is overlaid on the uploaded photo, and wherein the user selects at least a frame pattern and frame color, and the screen displays the frame pattern and color as will appear in the final photo magnet;
displaying a separate text box screen, wherein the user selects caption text for displaying with the overlay, and wherein the user may further select a font, a font size, and a font color for the caption text;
displaying a separate event icon screen wherein the user selects an icon representative of a chosen event from a palette of available icons;
completing the design of the photo magnet;
printing the photo magnet on magnetic photo paper; and
shipping the photo magnet to the user.

15. The method claimed in claim 14, wherein the completed design of the photo magnet with all user selections is shown in mockup form on each screen.

16. The method of claim 14, wherein the user selects a matte or gloss finish for the completed photo magnet design.

17. The method claim 14, wherein the user selects single shipping, wherein a chosen quantity of finished magnets is shipped to a single user address, or multiple shipping, wherein a chosen quantity of finished magnets is shipped to multiple persons at multiple addresses.

18. A method of providing a package of photo magnets related to a virtual video-conference event to multiple users, comprising the steps of:
providing an application for designing custom photo magnets, the application having a user interface accessible to the user as separate screens, each screen displaying prompts or menus, wherein the user provides selections in response to the prompts or menus;
obtaining a video recording of a virtual web-conferencing event;
using a screen capture application to capture multiple images of the virtual web-conferencing event and store the images in a digital storage medium;
displaying a photo upload screen via the user interface, wherein the user selects and uploads the source photos source from the digital storage medium;
displaying a frame selection screen, wherein a frame is overlaid on each uploaded photo, and wherein the user selects at least a frame pattern and frame color, and the screen displays the frame pattern and color as will appears in the final photo magnet;
displaying a separate text box screen, wherein user selects caption text for displaying within the overlay for each photo, wherein the user further selects a font, a font size, and a font color;
displaying a separate event icon screen for each photo, wherein the user selects an icon representative of a virtual event from a menu of icons;
completing the design of each photo magnet corresponding to each uploaded photo from the virtual event;
printing the photo magnets on magnetic photo paper for each uploaded photo;
packaging the photos related to the virtual event; and
shipping the photo magnet packages to multiple persons associated with the virtual event.

19. The method of claim 18, wherein photos are uploaded from screen captures of the virtual event conducted on the video conferencing website in real time.

20. The method of claim 18, wherein the screen captures are made from a recording of the virtual video-conferencing event after the event has concluded.
